(19) United States
(12) Patent Application Publication
(10) Pub. No.: US 2008/0222188 A1
(43) Pub. Date: Sep. 11, 2008

(54) Playlists responsive to coincidence distances

(75) Inventors: Stephen Watson, Toronto (CA); Andrew Marsh, Cork (IE)

Correspondence Address: KALEIDESCAPE, INC., 440 POTRERO AVE., SUNNYVALE, CA, 94085-4117, US

(73) Assignee: Kaleidescape, Inc., Mountain View, CA (US)

(21) Appl. No.: 11/714,088

(22) Filed: Mar. 5, 2007

(51) Int. Cl. G06F 17/00

(52) U.S. Cl. 707/102; 707/E17.045

(57) ABSTRACT

A method, apparatus, and memory storing instruction that generate one or more playlists. In one aspect, a playlist is generated by calculating coincidences distances between pairs of items in a group and generating a playlist of plural of the items in the group responsive to the coincidence distances. In another aspect, two related playlists are generated, for example by using a same coincidence criteria for the playlists or by using mutual similarity criteria between the playlists.

### BACKGROUND OF THE INVENTION

1. Field of the Invention

This invention relates to playlists for playing items that are responsive to one or more coincidence distances between items.

2. Related Art

Most modern compact disk players have a “random” play function. This function randomly plays songs on the CD. However, people are often unhappy with the results of the random function.

In particular, if the random function is truly random or even pseudo-random, one song is likely to play twice or even more times before all songs on the CD have been played. The same song could even be played twice in a row. Furthermore, two similar songs might be played back-to-back or near each other. A person listening to the songs might therefore perceive the play order to be repetitive, not random. In other words, a random play order might not be perceptually random to a listener.

On the other hand, a person might want to hear songs in a somewhat random order, with similar songs played closer together. Other types of partially random play order might also be desired. Conventional random play functions do not permit a person to experience these play orders.

Similar considerations can apply to playing other types of media, for example videos from a DVD, songs from an ipod, songs and videos stored in a computer or the like.

### SUMMARY OF THE INVENTION

The invention addresses the foregoing concerns by playing items such as songs or videos in a perceptually random as opposed to a truly or pseudo-random order.

Thus, one aspect of the invention is a method of generating a playlist of items. A preferred embodiment of the method includes the steps of calculating coincidences distances between pairs of items in a group and generating a playlist of plural of the items in the group responsive to the coincidence distances.

The group can be a group of items in a library such as a user's library of items, a group of items stored on media or in a memory of a device, a group of items in another playlist, or any other group of items. The group could include items selected by a user, for example through data entry or through insertion of media that includes the items. Other ways of determining the group can be used.

The playlist can be generated “on the fly” as items are played, without the playlist actually being stored. Alternatively, the playlist can be stored after being generated and then used to play the items or for some other purpose. Other techniques of implementing or using the playlist are within the scope of the invention.

In some embodiments, the playlist includes all of the items in the group. In other embodiments, less than all the items in the group are included in the playlist, for example responsive to a playlist length specified by a user.

The coincidence distances can be computed based on a wide variety of information about and characteristics of the items. In particular, the coincidence distances can be calculated responsive to metadata associated with the items. Such metadata can include, for example, characteristics of the items, play lengths of the items, minimum play lengths of the items, ratings specified by a user, signal analysis performed on the items, and other data associated with the items. The coincidence distances also can be calculated responsive to other factors in addition to or instead of the metadata, including but not limited to data akin to the metadata but not included in the metadata (e.g., from another source), and/or comparisons of the positions of items (i.e., distances in terms of numbers of items between the items).

Preferably, the coincidence distances are calculated by evaluating one or more functions referred to as coincidence measures. The coincidence measures preferably are evaluated between items in the group and items already selected for the playlist. In a preferred embodiment, the coincidence measure is a function of both similarity and distance. Some or all of the items in the group can be evaluated in this fashion. Other coincidence distances, coincidence measures, and way of calculating coincidence distances can be used.

One or more coincidence criteria preferably are used to evaluate the calculated coincidence distances in order to determine which items in the group to include in the playlist. In a preferred embodiment, one or more items in the group that are not already on the playlist are placed on the playlist if coincidence distances between the items in the group and at least one item in the group that is already on the playlist meet a coincidence criterion. The criterion can be that the coincidence distance is greater than a threshold, which encourages randomness, less than the threshold, which encourages similarity, or within a pair of thresholds, which encourages a perception of “flow.” These criteria and/or other coincidence criteria can be used to try to have different sounding or types of items play near each other, to have similar sounding or types of items play close to each other, or to achieve other types of perceptual randomness, partial randomness, or flow.

In some cases, more than one item will meet the coincidence criterion. In such cases, one or more of these items might be chosen for inclusion on the list. For example, one or more of the items could be selected for inclusion based on (a) an order of calculation of the coincidence distances, (b) random selection of one or more items from the items that meet the coincidence criterion, (c) user selection, (d) determination of which item or items meet the coincidence criterion the “best” in some mathematical or statistical sense. Other techniques can be used. If an item that meets the criterion is not selected, that item preferably is considered again for later inclusion in the list.

In some embodiments, an additional coincidence criterion that can be used is that repetitions in the playlist are avoided until all of the items in the group have been placed in the playlist, and/or that repetitions in the playlist are avoided until all of the items in a genre in the group have been placed in the playlist. Genre can be determined responsive to metadata associated with the items.

A variability parameter also can be used when applying one or more coincidence criteria to the coincidence measures. The variability parameter varies how many items should, will, or do meet the coincidence criteria. In some embodiments, the variability parameter specifies a minimum number of items that should satisfy the coincidence criteria. The criteria can then be relaxed (or tightened) to try to ensure that number of items satisfy the criteria.

In preferred embodiments, the coincidence criterion or criteria that is used, the variability parameter, or both are responsive to input from a user.

In some embodiments, some or all items in the group are placed on the playlist in such a way that the playlist satisfies one or more coincidence criteria better than other possible playlists. It would often be computationally infeasible to calculate all such possible playlists. Therefore, the set of possible playlists considered most likely will be less than all possible playlists. Nonetheless, algorithms exist that can be used to approximate a playlist that is best compared to all other possible playlists. Simulated annealing is one such algorithm that is well understood, although it has not been applied to playlist generation as disclosed herein.

Another aspect of the invention is a method of generating two playlists. A preferred embodiment of this method includes the following steps: generating a first playlist from a first group of items, and generating a second playlist from a second group of items, with generation of the second playlist related to generation of the first playlist.

The generation of the playlists can be related in many ways. In some embodiments, a same coincidence criteria is used to generate the first and second playlists. In another embodiment, mutual similarity criteria is applied to generation of the first playlist and the second playlist. Other embodiments exist.

In some embodiments, items on the first playlist, the second playlist, or both, can be truncated or expanded so that items at same positions in the playlists play in a same amount of time.

Once one or more playlists are generated, the playlists can be used or altered in various ways. Examples include, but are not limited to, playing items from a playlist in order, automatically altering a playlist based on which of the items have been included in a previously generated playlist or based on some other factor, displaying a playlist to a user, permitting a user to remove items from or otherwise to alter the playlist, and the like. In other embodiments, the playlist could be strictly internal to a device, which could use the playlist while hiding it from a user.

The invention also encompasses apparatuses that can perform the foregoing methods, as well as memories that store instruction that execute these methods.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE FIGURES

FIG. 1 shows an embodiment of an apparatus that can be used for generating playlists according to the invention.

FIG. 2 is a block diagram illustrating generation of a playlist from a group of items such as songs or videos.

FIG. 3 is a flowchart illustrating one possible method of generating a playlist from a group of items.

FIG. 4 illustrates some possible types of information that can be used when calculating coincidence distances.

FIG. 5 illustrates avoidance of repetitions when generating a playlist.

FIG. 6 is a flowchart illustrating one method of generating related playlists.

FIG. 7 is a block diagram illustrating some possible relationships that can be used when generating related playlists.

### DETAILED DESCRIPTION OF THE INVENTION

The invention generally relates to generation of one or more playlists of items such as, but not limited to, songs from a CD, DVD, or ipod, videos (with or without audio) from a DVD or videotape, songs and video stored in a memory, computer or other device, other multimedia, and the like.

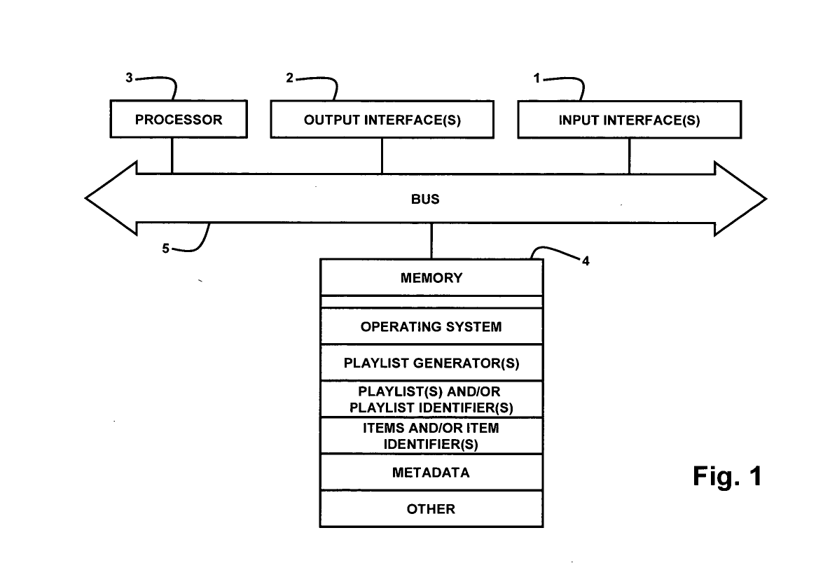

FIG. 1 shows an embodiment of an apparatus that can be used for generating playlists according to the invention.

The apparatus in FIG. 1 includes input interface(s) 1, output interface(s) 2, processor 3, and memory 4 that communicate with each other over bus 5. The apparatus could be a general purpose computer, a specialized multimedia apparatus, an audio, video, or multimedia player, or the like. Thus, additional elements not shown in FIG. 1 might be present.

The input interface(s) include at least an interface to any type of input device through which information about items for a playlist and/or the items themselves can be input into the apparatus. Examples of such input devices include, but are not limited to, an audio input device, a video input device, a media reader (e.g., CD or DVD reader), a multimedia input device, a text input device, or a computing device. The input interface(s) can also include interfaces to any other types of input devices, including but not limited to user input devices such as a keyboard, device controls, and the like, an interface to a communication or network device, and the like. Other types of input interfaces and devices can be used.

The output interface(s) include at least an interface to any type of output device through which information about items in a playlist and/or the items themselves can be output from the apparatus. Examples of such output devices include, but are not limited to, an audio output device, a video output device, a media writer (e.g., CD or DVD burner), a multimedia output device, a text output device, or a computing device. The output interface(s) can also include interfaces to any other types of output devices, including but not limited to user output devices such as a screen, device display, and the like, an interface to a communication or network device, and the like. Other types of output interfaces and devices can be used.

The processor executes instructions stored in the memory to perform playlist generation according to the invention. The processor can be a general purpose processor, a CPU of a computer, a specialized processor, a processor in an audio, video, or multimedia player, or the like.

The memory stores data and instructions executable by the processor to generate one or more playlists as described in the following sections, as well as possibly performing other functions. The memory typically will include at least some form of operating system for the apparatus, instructions for generating playlists, the playlists and items and/or identification of playlists and items, possibly metadata associated with the items, and other instructions and data. For example, if the processor is a CPU of a computer, the memory could also store operating instructions, programs, and data for the computer to perform its other functions.

Even though input interface 1, output interface 2, processor 3, and memory 4 are shown as single blocks, some or all of these elements may be combined or may include multiple different parts of a same or different type. For example, plural input interfaces and output interfaces could be present, one interface could serve as both an input interface and an output interface, plural processors of different types could be present, and different types of memories such as RAM, ROM, flash drive(s), other removable media, and/or mass storage could be present.

Other apparatuses besides the one shown in FIG. 1 also can be used to implement the invention.

### Independent Playlist Generation

Briefly, one embodiment of the invention is a method of generating a playlist of items from a group of items. The method includes the steps of calculating coincidence distances between pairs of items in the group, and generating a playlist of plural of the items in the group responsive to the coincidence distances.

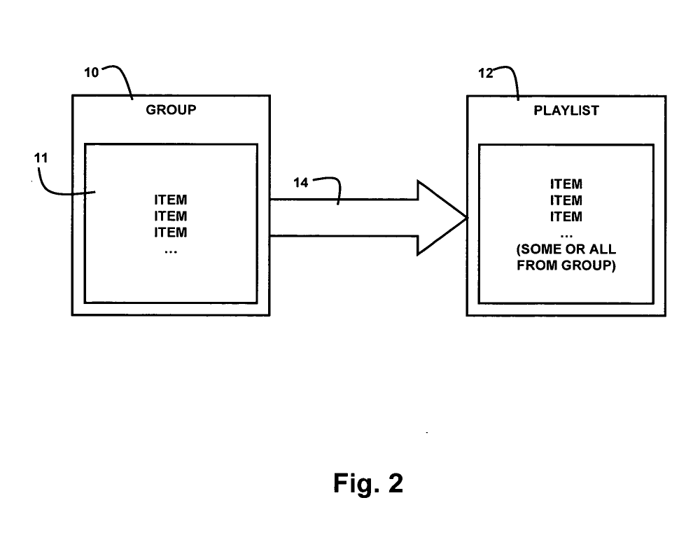

Thus, FIG. 2 shows group 10 of items ii. The items could be, for example, songs from a CD, DVD, or ipod, videos (with or without audio) from a DVD or videotape, songs and video stored in a memory, media, computer or other device, other multimedia, and the like. In some embodiments, group 10 is a group of items in a user's library, a group of items stored on media or in a memory of a device, items in a previously generated or other playlist of items, or a group of items selected by a user. Other items and groups of items can be used with the invention.

According to the invention, playlist 12 is generated from items 11 in group 10, as illustrated by arrow 14. In some embodiments, the playlist includes all of the items in the group. In other embodiments, less than all the items in the group are included in the playlist, for example responsive to a playlist length specified by a user.

The playlist preferably is generated as items in the playlist are being played by a device such as the apparatus shown in FIG. 1. Alternatively, playlist can be stored for later access and/or use after being generated.

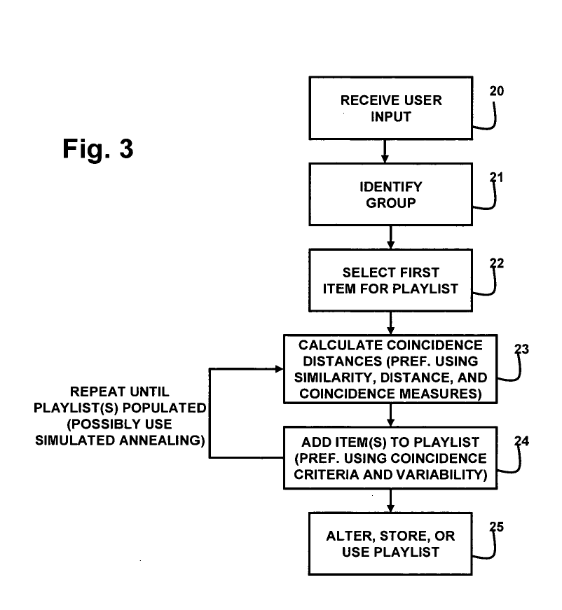

FIG. 3 is a flowchart showing one possible method for generating a playlist from a group of items. Although the steps in FIG. 3 are shown in a particular order for ease of description, many of the steps can be performed in a different order, in parallel, in a pipelined manner, and the like.

In step 20, user input is received. This input can include any factors discussed below that affect generation of a playlist.

In step 21, a group of items is identified from which a playlist is to be generated. The group and the items in the group can be identified using any method or technique from any source. Examples include, but are not limited to, the following:
identification of or access to one or more pieces of media that contain items in the group;
identification of or access to items stored in memory for inclusion in the group;
identification of or access to a library containing the items for inclusion in the group;
identification of or access to an online source such as a website for items for inclusion in the group;
identification of or access to another playlist of items, for example a previously generated playlist of items;
any other form of data input or access that identifies or accesses items for inclusion in the group; and
any combination thereof.
   The identification can be through user input, by a device without user input, any combination thereof, or by any other technique. Access can be local, remote (e.g., over the world wide web), any combination thereof, or by any other technique.

In step 22, an item from the group is selected as a first item in the playlist. This item can be selected randomly, responsive to user input, based on its position in the group (if the group is ordered), or in any other manner.

In step 23, coincidence distances are calculated between pairs of items in the group. Coincidence distances can be calculated between some or all pairs of items in the group. The coincidence distances preferably are calculated between items in the group that are not on the playlist and items in the group that are already on the playlist. For example, if the group includes items A, B, C, D, E, F, G, H, I, J, and K, and the playlist already includes items C, F, and J, coincidence distances preferably are calculated for some or all of the following pairs of items: A & C, A & F, A & J, B & C, B & F, B & J, D & C, D & F, D & J, E & C, E & F, E & J, G & C, G & F, G & J, H & C, H & F, H & J, I & C, I & F, I & J, K & C, K & F, and K & J.

Alternatively, coincidence distances can be calculated for different pairings of items. In particular, for large groups of items, coincidence distances could be calculated for fewer pairings than all possible combinations of items not on the playlist and items already on the playlist. For a first example, coincidence distances could be calculated only between items in the group and n number of items already on the playlist, thereby lessening computational demands. For a second example, coincidence distances could be calculated for random pairing. This example is particularly suitable for simulated annealing, discussed below. Other techniques for selecting pairings can be used.

Preferably, the coincidence distances are calculated by evaluating one or more functions referred to as coincidence measures. A coincidence measure preferably has the following properties:
The coincidence measure depends on the similarity of the items as calculated from metadata or other information associated with the items or the similarity of the items as calculated by the performance of a signal analysis on the items or any combination of the above.
The coincidence measure depends on the distance between the items in the playlist i.e. the number of items that occur in the playlist between the first of the two items and the second of the two items, hereafter called the playlength distance.
The coincidence measure has the property that the coincidence distance of any pair of items on any playlist is greater than or equal to the coincidence distance of any pair of items at the same position on a different playlist when this second pair of items are more similar.
The coincidence measure has the property that the coincidence distance of any pair of items from any playlist that occur at one playlength distance is less than the coincidence distance of this same pair of items when they occur in another playlist at a greater playlength distance.

Alternatively, different coincidence measures that have some or even none of the foregoing properties can be used, as long as the measure results in coincidence distances between items that indicate in some manner a similarity or dissimilarity between the items.

In some embodiments that are intended to have at least some of the foregoing properties, the coincidence measure is a function that multiplies similarity metrics by distance metrics. Preferably, similarity is measured between an item in the group and an item already selected for the playlist, and distance is measured between an available position on the playlist and a position of an item already selected for the playlist.

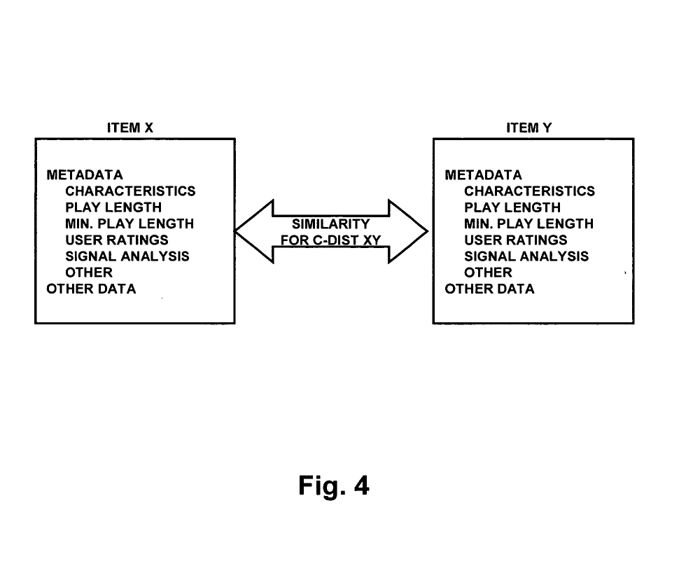

The similarity metrics can be responsive to a wide variety of information about and characteristics of the items. As shown in FIG. 4, this information can come from metadata associated with the items. Such metadata can include, for example, some or all of the following: characteristics of the items, play lengths of the items, minimum play lengths of the items, ratings specified by a user, signal analysis performed on the items, current or past “rankings” or “ratings” of the items, for example whether or not the items were “hits” and for how long they were “hits,” and other data associated with the items. As also shown in FIG. 4, the similarity metrics can be responsive to other information about the items in addition to or instead of the metadata, including but not limited to data akin to the metadata but not included in the metadata (e.g., from another source).

In some embodiments, the selection of which information is considered is pre-set. In other embodiments, the selection of which information is considered is selected by a user, for example through device controls or through a user interface. Other techniques for selecting what information to consider can be used.

Any method of comparing the information can be used to determine the similarity metrics. Examples include, but are not limited to, word matching, keyword matching, cross-correlation on numerical values in the information, simple mathematics performed on numerical values in the information, and any other technique that provides some indication of similarity or dissimilarity.

Preferably, a function for determining the distance metrics is a non-decreasing function of a distance between items on the playlist. In some embodiments, the function is simply a measure of a playlength distance between a (preferably next) available position on the playlist and existing items on the playlist. For example, if the group includes items A, B, C, D, E, F, G, H, I, J, and K, and the playlist already includes items F, J, and C in that order, then the distance between the next available (i.e., fourth) position on the playlist and item F would be 3, the distance between the next available position and item J would be 2, and the distance between the next available position and item C would be 1. Other techniques and measures of distance can be used to determine the distance metrics.

As noted above, in some embodiments, the coincidence measure between an item not on the playlist and an item on the playlist is a function that multiplies a similarity metric for the items by a distance metric for the items.

An embodiment along these lines can be expressed mathematically as follows: if the playlist is x_{—}1,x_{—}2, . . . and f is the similarity metric, then f(x_{—}1,x_{—}2) is low if x_{—}1 and x_{—}2 are similar. If g is the distance metric, then g(1,2) measures the distance in the sequence between positions 1 and 2. The function g might be absolute value of the difference, but it can also be more flexible. Apparent coincidence (i.e., coincidence distance) between two items may be measured by e(i,j)=h(f(x_i,x_j),g(i,j) when h is some function monotone in both arguments (it could be just the product), and h is lowest when there is greatest coincidence.

In some embodiments, the coincidence measure can also automatically alter coincidence distances responsive to a previously generated playlist. For example, a coincidence measure could alter a coincidence distance for a pair of items that occurred consecutively in a recent playlist. If the coincidence criteria for a new playlist include the criterion that the coincidence distance of any two items should be large, then this type of coincidence measure could decrease a likelihood of this same pair of items occurring at a small playlength distance on the new playlist.

Other techniques for determining coincidence distances and/or coincidence measures. These techniques can use the same type of information as discussed above or other information.

In step 24, one or more items are added to the playlist responsive to evaluation of the coincidence distances using coincidence criteria.

One or more coincidence criteria preferably are used to evaluate the calculated coincidence distances in order to determine which items in the group to include in the playlist. In a preferred embodiment, one or more items in the group that are not already on the playlist are placed on the playlist if coincidence distances between the items in the group and at least one item in the group that is already on the playlist meet a coincidence criterion. The criterion can be that the coincidence distance is greater than a threshold, which encourages randomness, less than the threshold, which encourages similarity, or within a pair of thresholds, which encourages a perception of “flow.” These criteria and/or other coincidence criteria can be used to try to have different sounding or types of items play near each other, to have similar sounding or types of items play close to each other, or to achieve other types of perceptual randomness, partial randomness, or flow.

In some embodiments, perceptual randomness could be enhanced by using coincidence criteria that maximizes the minimum of e (apparent coincidence) over all pairs. Alternatively, a pair of item with a certain number of moderate coincidence distances could be deemed to be more perceptually random than a pair of items with an extreme distance.

An additional coincidence criterion that can be used is that the generated playlist avoids repetitions. Use of such a criterion tends to enhance perceptual randomness.

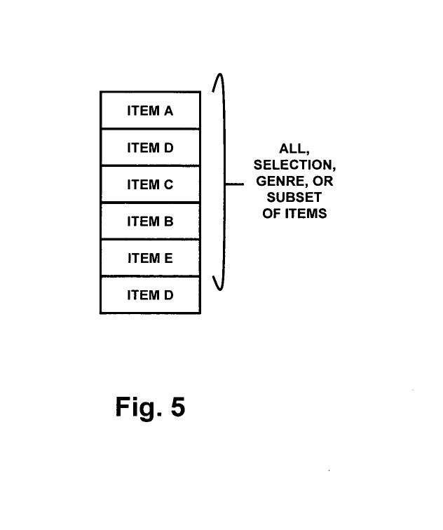

The repetitions can be avoided for the whole playlist, for a selection of items, for a particular genre, or for any other set or subset of items. This is illustrated in FIG. 5, in which items A to E are all items that can be placed in the playlist, a selection of items, a genre of items, or some other set or subset of items, and none of the items repeats until all of items A to E have occurred. The selection of items, genre, or other subset for which repetitions are to be avoided can be determined responsive to metadata associated with the items, to user input, or to any other relevant information, from a source either external or internal to a device that is generating the playlist.

Alternatively, a “local” criterion that permits repetitions beyond n number of items on the playlist could be used. This type of criterion could be implemented by applying other coincidence criteria only to coincidence distances for pairs of items on the playlist that have a playlength distance less than n.

The type of coincidence criteria that are implemented or applied can settable, for example responsive to input from a user. If the criteria are selected responsive to user input, the criteria could be selected from a list of pre-set coincidence criteria presented to the user. Examples of such criteria could be labeled intuitively, for example “Play All” (avoids repeats until all items have occurred), “Play Flow” (uses a minimum or a range of thresholds as the criteria), and the like. Other techniques for the user to input the coincidence criteria can be used. Alternatively, the criteria can be determined through pre-sets or through any other technique.

If coincidence distances between an item not already on the playlist and other items already on the playlist meet the coincidence criterion or criteria, the item is said to meet the coincidence criterion or criteria. In some cases, more than one item will meet the coincidence criterion or criteria. In such cases, one or more of these items might be chosen for inclusion on the list. For example, one or more of the items could be selected for inclusion based on (a) an order of calculation of the coincidence distances, (b) random selection of one or more items from the items that meet the coincidence criterion, (c) user selection, (d) determination of which item or items meet the coincidence criterion or criteria the “best” in some mathematical or statistical sense. Other techniques can be used. If an item that meets the criterion is not selected, that item preferably is considered again for later inclusion in the list.

A variability parameter also can be used when applying one or more coincidence criteria to the coincidence measures. The variability parameter varies how many items should, will, or do meet the coincidence criteria. In some embodiments, the variability parameter specifies a minimum number of items that should satisfy the coincidence criteria. The criteria can then be relaxed (or tightened) to try to ensure that number of items satisfy the criteria.

In some embodiments, whether a variability parameter is used and/or a value for the variability parameter are responsive to input from a user. For example, the user could select these factors from a list using a graphical user interface. Alternatively, a simple input control such as a button, slide or knob could be used to specify a minimum number of items for the playlist, which would in turn set the variability parameter. Other techniques for the user to input thes factors can be used. Alternatively, the factors can be determined through pre-sets or through any other technique.

Steps 23 and 24 (and possibly other steps) can be repeated to determine a next item to be placed on the playlist. The steps can be repeated until the playlist is fully populated, for example by adding items until the playlist meets a playlist length specified by a user.

Alternatively, steps 23 and 24 (and possibly other steps) can be repeated to try to determine a playlist that satisfies one or more coincidence criteria better than other possible playlists.

It would often be computationally infeasible to calculate all such possible playlists. Therefore, the set of possible playlists considered most likely will be less than all possible playlists. Nonetheless, algorithms exist that can be used to approximate a playlist that is better compared to all (or most) other possible playlists. Simulated annealing is one such algorithm that is well understood, although it has not been applied to playlist generation as disclosed herein. A general description of simulated annealing can be found at http://mathworld.wolfram.com/SimulatedAnnealing.html. Application of such simulated annealing to steps 22 through 24 would not require undue experimentation or further invention, and is within the scope of the invention.

In step 25, the playlist is altered, stored, or used. For example, items in the playlist could be played in order, either “on the fly” or from memory. Thus, a library of recently generated playlists could be stored for selection and use. The playlist also can be used in other ways, for example by being displayed to a user. In other embodiments, the playlist might be for strictly internal use by a device, in which case it could be hidden from the user. Other uses are possible.

A generated playlist can be altered either automatically or by a user.

As an example of automatic alteration, the playlist could be altered based on which of the items have been included in a previously generated playlist responsive to the coincidence distances. As an example of manual alteration, a user could add, remove, and/or change an order of items on the playlist through a user interface. The playlist can be altered in other ways as well.

The playlist also could be altered to better satisfy one or more coincidence criteria.

For a first example, the playlist could be checked to see if all items in the playlist (or even just a group of items generated in some other fashion) meet the coincidence criteria. If the items do not all meet the criteria, positions of at least two items in the playlist could be changed. Then, the playlist could be checked again. This process could continue until either all items meet the coincidence criteria or until some number of iterations has been performed.

For a second example, positions of items on the playlist could be changed, either according to some algorithm, randomly, or pseudo-randomly. The altered list could then be checked to see if it better satisfies the coincidence criteria than other orders that have been checked. The better list could be retained. This process could be repeated a fixed number of times or a number of times until a number of pairs of items that fail to satisfy the coincidence criteria is less than some threshold, for example as selected by a user or by a system.

For a third example, simulated annealing could be performed at this step after the items for the playlist have been selected in steps 23 and 24. Again, simulated annealing could help to approximate a playlist that better satisfies the coincidence criteria or criterion as compared to other possible playlists having the selected items.

The playlist can be altered in other ways as well.

### Related Playlist Generation

A variation of the foregoing techniques is to generate two related playlists from two base groups of items. For example, two playlists of complementary items such as audio items and video items could be generated, permitting a perceptually random audio and visual experience. Two playlists of same or different types of items could be generated for other purposes.

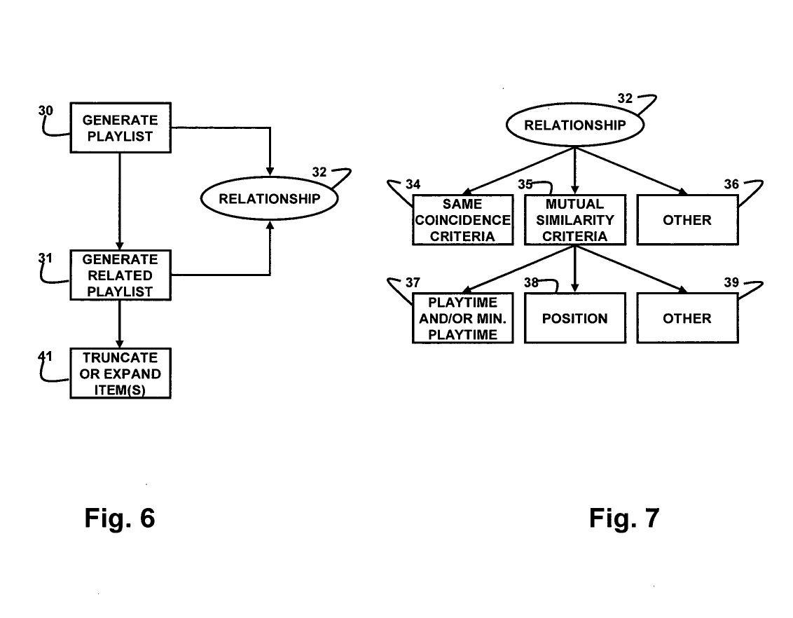

FIG. 6 is a flowchart of one embodiment of a method that generates two related playlists. Although the steps in FIG. 6 are shown in a particular order for ease of description, many of the steps can be performed in a different order, in parallel, in a pipelined manner, and the like.

In step 30, a first playlist is generated from a first group of items. In step 31, a second playlist is generated from a second group of items. The groups can be the same or different, and they can be related or unrelated.

Steps 30 and 31 preferably proceed substantially as described above with respect to FIG. 3, except that step 31 is modified responsive to step 30. Thus, the two generated playlists are related. Element 32 represents this relationship.

FIG. 7 illustrates that the relationship 32 between the generated playlists can be application of a same coincidence criteria 34, application of mutual similarity criteria 35, or some other relationship 36. The mutual similarity criteria can in turn be related to position 37 or playtime 38 for the items, as well as to other factors 39.

In more detail, one way in which generation of the playlists can be related is by using a same coincidence criterion or criteria to generate the first playlist and the second playlist.

Another way in which generation of the playlists can be related is by application of mutual similarity criteria. The mutual similarity criteria preferably tends to help similarly placed items in the two playlists correspond in some fashion.

For example, the mutual similarity criteria could be related to positions of the items in their respective groups (if the groups are ordered). Thus, if the groups were positionally related in some way before generation of the perceptually random playlists, they might still be somewhat coordinated despite their apparent randomness.

For another example, the mutual similarity criteria could be that similarly positioned items in the playlists should have matching or permissibly matching playtimes. Playtimes for items are permissibly matching as long as the shorter item's playtime is not less than a minimum playtime for the other item, for example as defined in metadata for the items. One way to implement this mutual similarity criterion is to use a degree that playtimes of items in the second group match playtimes of items in the first playlist as the coincidence criterion for generation of the second playlist.

Other type of relationships and mutual similarity might be used.

The related playlists might be played concurrently. However, even with application of mutual similarity criteria, like positioned items in the playlists might not have a same playtime. In that case, the items can be truncated or expanded, for example through fade-out or blank play time, so that the items match temporally. This operation is illustrated as optional step 41 in FIG. 6.

When playing a playlist the transition from each song to the next may occur in a number of different ways. For example the first song may fade out rather than play to the end. The management of these transitions may involve the metadata, in particular the minimum time taken to play that song. Other techniques for aligning the items can be used as well.

### Generality of Invention

Steps for possible embodiments of the invention have been described above. Preferably, the steps are executed in the order shown. However, the invention also encompasses embodiments in which the steps are executed in different orders, where possible, and in different arrangements, for example in parallel.

Furthermore, this application should be read in the most general possible form. This includes, without limitation, the following:
References to specific techniques include alternative and more general techniques, especially when discussing aspects of the invention, or how the invention might be made or used.
References to “preferred” techniques generally mean that the inventor contemplates using those techniques, and thinks they are best for the intended application. This does not exclude other techniques for the invention, and does not mean that those techniques are necessarily essential or would be preferred in all circumstances.
References to contemplated causes and effects for some implementations do not preclude other causes or effects that might occur in other implementations.
References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

What is claimed is:

1. A method of generating a playlist of items from a group of items, comprising the steps of:
calculating coincidence distances between pairs of items in the group; and
generating a playlist of plural of the items in the group responsive to the coincidence distances.

2. A method as in claim 1, wherein the items are songs or videos.

3. A method as in claim 1, wherein the group is a group of items in a user's library.

4. A method as in claim 1, wherein the group is a group of items stored on media or in a memory of a device.

5. A method as in claim 1, wherein the group is another playlist of items.

6. A method as in claim 1, wherein the group includes items selected by a user.

7. A method as in claim 1, wherein the playlist is generated as items in the playlist are being played.

8. A method as in claim 1, wherein the playlist is stored after being generated.

9. A method as in claim 1, wherein the playlist includes all items in the group.

10. A method as in claim 1, wherein the playlist includes less than all items in the group responsive to a playlist length specified by a user.

11. A method as in claim 1, wherein the coincidence distances are calculated responsive to metadata associated with the items in the group.

12. A method as in claim 11, wherein the metadata includes one or more of the following: characteristics of the items, play lengths of the items, minimum play lengths of the items, ratings specified by a user, signal analysis performed on the items, and current or past rankings or ratings of the items.

13. A method as in claim 1, wherein the coincidence distances are calculated by evaluating a coincidence measure between items in the group and items already selected for the playlist.

14. A method as in claim 13, wherein the coincidence measure between an item in the group and an item already selected for the playlist is a function of both similarity and distance, with the similarity measured between the item in the group and the item already selected for the playlist, and with the distance measured between an available position on the playlist and a position of the item already selected for the playlist.

15. A method as in claim 13, wherein one or more items in the group that are not already on the playlist are placed on the playlist if coincidence distances between the items in the group and at least one item in the group that is already on the playlist meet a coincidence criterion.

16. A method as in claim 15, wherein plural items in the group that are not already on the playlist meet the coincidence criterion.

17. A method as in claim 16, wherein one or more of the items that meet the coincidence criterion are placed on the playlist based on one or more of: (a) an order of calculation of the coincidence distances, (b) random selection of one or more of the items that meet the coincidence criterion, (c) user selection, and (d) determination of which item or items best meet the coincidence criterion mathematically or statistically.

18. A method as in claim 15, wherein one or more additional coincidence criteria are also used to determine if an item in the group should be placed on the playlist.

19. A method as in claim 18, wherein one of the additional coincidence criteria is that repetitions in the playlist are avoided until all of the items in the group have been placed in the playlist.

20. A method as in claim 18, wherein one of the additional coincidence criteria is that repetitions in the playlist are avoided until all of the items in a genre in the group have been placed in the playlist.

21. A method as in claim 15, wherein the coincidence criterion is that the coincidence distance is greater than a threshold, less than the threshold, or within a pair of thresholds.

22. A method as in claim 15, wherein a variability parameter is used when applying the coincidence criterion.

23. A method as in claim 22, wherein the variability parameter specifies a minimum number of items that should satisfy the coincidence criterion.

24. A method as in claim 23, wherein the coincidence criterion is relaxed to ensure that the number of items that would satisfy the coincidence criteria if chosen is at least the minimum number specified by the variability parameter.

25. A method as in claim 22, wherein the coincidence criterion, the variability parameter, or both are responsive to input from a user.

26. A method as in claim 1, further comprising the step of playing items from the playlist in order.

27. A method as in claim 1, further comprising the step of automatically altering the playlist.

28. A method as in claim 27, wherein the playlist is altered based on which of the items have been included in a previously generated playlist.

29. A method as in claim 27, wherein the playlist is altered to generate a playlist that better satisfies one or more coincidence criteria.

30. A method as in claim 29, wherein the playlist is altered through simulated annealing.

31. A method as in claim 29, wherein the playlist is altered by changing positions of items in the playlist and checking to see if the playlist with changed positions better satisfies the coincidence criteria.

32. A method as in claim 31, wherein the positions of items in the playlist are changed a fixed number of times.

33. A method as in claim 31, wherein the positions of items in the playlist are changed repeatedly and the playlist is checked until a number of pairs of items that fail to satisfy the coincidence criteria is less than some threshold.

34. A method as in claim 1, further comprising the step of displaying the playlist to a user.

35. A method as in claim 34, further comprising the step of permitting the user to remove items from or otherwise to alter the playlist.

36. A method as in claim 1, further comprising the step of hiding the playlist from a user.

37. A method of generating two playlists, comprising the steps of:
generating a first playlist from a first group of items; and
generating a second playlist from a second group of items;
wherein generation of the second playlist is related to generation of the first playlist.

38. A method as in claim 37, wherein the first group of items includes identical items as the second group of items.

39. A method as in claim 37, wherein the first group of items includes one or more different items than the second group of items.

40. A method as in claim 37, wherein the items in the first group are songs and the items in the second group are videos.

41. A method as in claim 37, wherein generation of the playlists is related by using a same coincidence criterion or criteria to generate the first playlist and the second playlist.

42. A method as in claim 37, wherein generation of the playlists is related by applying a mutual similarity criterion to the generation of the playlists.

43. A method as in claim 42, wherein the mutual similarity criteria is related to positions of the items in the groups.

44. A method as in claim 42, wherein the mutual similarity criteria is related to a play time of each item.

45. A method as in claim 37, wherein items in the first playlist, the second playlist, or both are truncated or expanded so that items at same positions in the playlists play in a same amount of time.

46. An apparatus that generates a playlist, comprising:
one or more input interfaces, including at least an input interface through which a group of items can be input;
one or more output interfaces, including at least an output interface through which a playlist of items, the items in the playlist, or both can be output;
a processor that executes instructions; and
a memory that stores information including the instructions, the instructions including the steps of:
calculating coincidence distances between pairs of items in the group; and
generating a playlist of plural of the items in the group responsive to the coincidence distances.

47. An apparatus as in claim 46, wherein the items are songs or videos.

48. An apparatus as in claim 46, wherein the group is a group of items in a user's library, and wherein the memory stores identification of the group of items, the group of items, or both.

49. An apparatus as in claim 46, wherein the group is a group of items stored on media that can be input through the input interface.

50. An apparatus as in claim 46, wherein the playlist is generated as items in the playlist are being played though the output interface.

51. An apparatus as in claim 46, wherein the memory further stores metadata associated with items in the group or the metadata is accessible through the input interface, and wherein the coincidence distances are calculated responsive to the metadata.

52. An apparatus as in claim 51, wherein the metadata includes one or more of the following: characteristics of the items, play lengths of the items, minimum play lengths of the items, ratings specified by a user, signal analysis performed on the items, and current or past rankings or ratings of the items.

53. An apparatus as in claim 46, wherein the coincidence distances are calculated by evaluating a coincidence measure between items in the group and items already selected for the playlist.

54. An apparatus as in claim 53, wherein the coincidence measure between an item in the group and an item already selected for the playlist is a function of both similarity and distance, with the similarity measured between the item in the group and the item already selected for the playlist, and with the distance measured between an available position on the playlist and a position of the item already selected for the playlist.

55. An apparatus as in claim 53, wherein one or more items in the group that are not already on the playlist are placed on the playlist if coincidence distances between the items in the group and at least one item in the group that is already on the playlist meet a coincidence criterion.

56. An apparatus as in claim 55, wherein plural items in the group that are not already on the playlist meet the coincidence criterion.

57. An apparatus as in claim 56, wherein one or more of the items that meet the coincidence criterion are placed on the playlist based on one or more of: (a) an order of calculation of the coincidence distances, (b) random selection of one or more of the items that meet the coincidence criterion, (c) user selection, and (d) determination of which item or items best meet the coincidence criterion mathematically or statistically.

58. An apparatus as in claim 55, wherein one or more additional coincidence criteria are also used to determine if an item in the group should be placed on the playlist.

59. An apparatus as in claim 58, wherein one of the additional coincidence criteria is that repetitions in the playlist are avoided until all of the items in the group have been placed in the playlist.

60. An apparatus as in claim 58, wherein one of the additional coincidence criteria is that repetitions in the playlist are avoided until all of the items in a genre in the group have been placed in the playlist.

61. An apparatus as in claim 55, wherein the coincidence criterion is that the coincidence distance is greater than a threshold, less than the threshold, or within a pair of thresholds.

62. An apparatus as in claim 55, wherein a variability parameter is used when applying the coincidence criterion.

63. An apparatus as in claim 62, wherein the variability parameter specifies a minimum number of items that should satisfy the coincidence criterion.

64. An apparatus as in claim 63, wherein the coincidence criterion is relaxed to ensure that the number of items that would satisfy the coincidence criteria if chosen is at least the minimum number specified by the variability parameter.

65. An apparatus as in claim 62, wherein the coincidence criterion, the variability parameter, or both are responsive to input from a user.

66. An apparatus as in claim 46, wherein the instructions further comprise the step of playing items from the playlist in order through the output interface.

67. An apparatus as in claim 46, wherein the instructions further comprise the step of automatically altering the playlist.

68. An apparatus as in claim 67, wherein the playlist is altered based on which of the items have been included in a previously generated playlist.

69. An apparatus as in claim 67, wherein the playlist is altered to generate a playlist that better satisfies one or more coincidence criteria.

70. An apparatus as in claim 69, wherein the playlist is altered through simulated annealing.

71. An apparatus as in claim 69, wherein the playlist is altered by changing positions of items in the playlist and checking to see if the playlist with changed positions better satisfies the coincidence criteria.

72. An apparatus as in claim 71, wherein the positions of items in the playlist are changed a fixed number of times.

73. An apparatus as in claim 71, wherein the positions of items in the playlist are changed repeatedly and the playlist is checked until a number of pairs of items that fail to satisfy the coincidence criteria is less than some threshold.

74. An apparatus as in claim 46, wherein the instructions further comprise the step of sending the playlist to the output interface for displaying to a user.

75. An apparatus as in claim 74, wherein the instructions further comprise the step of permitting the user to remove items from or otherwise to alter the playlist.

76. An apparatus as in claim 46, wherein the instructions further comprise the step of hiding the playlist from a user.

77. An apparatus that generates playlists, comprising:
one or more input interfaces, including at least an input interface through which one or more groups of items can be input;
one or more output interfaces, including at least an output interface through which the playlists of items, the items in the playlists, or both can be output;
a processor that executes instructions; and
a memory that stores information including the instructions, the instructions including the steps of:
generating a first playlist from a first group of the items; and
generating a second playlist from a second group of the items;
wherein generation of the second playlist is related to generation of the first playlist.

78. An apparatus as in claim 77, wherein the first group of items includes identical items as the second group of items.

79. An apparatus as in claim 77, wherein the first group of items includes one or more different items than the second group of items.

80. An apparatus as in claim 77, wherein the items in the first group are songs and the items in the second group are videos.

81. An apparatus as in claim 77, wherein generation of the playlists is related by using a same coincidence criterion or criteria to generate the first playlist and the second playlist.

82. An apparatus as in claim 77, wherein generation of the playlists is related by applying a mutual similarity criterion to the generation of the playlists.

83. An apparatus as in claim 82, wherein the mutual similarity criteria is related to positions of the items on the playlists.

84. An apparatus as in claim 82, wherein the mutual similarity criteria is related to a play time of each item.

85. An apparatus as in claim 77, wherein items in the first playlist, the second playlist, or both are truncated or expanded so that items at same positions in the playlists play in a same amount of time.
